(19) United States
(12) Patent Application Publication
(10) Pub. No.: US 2017/0154325 A1
(43) Pub. Date: Jun. 1, 2017

(54) SYSTEMS, METHODS, HARDWARE, AND ARCHITECTURE FOR ENABLING WORLDWIDE PAYMENTS OF PURCHASES FROM AN ECOMMERCE PLATFORM USING A SMARTPHONE PAYMENT SYSTEM

(71) Applicant: SENDLATER, INC., Woodstock, VT (US)

(72) Inventors: John J. Donovan, Hamilton, MA (US); Paul D. Parisi, Boxford, MA (US); Sahil S. Sachdev, Cambridge, MA (US); Joshua Paredes, Salem, MA (US); Benjamin Coole, Somerville, MA (US); Jennifer Faucon, Ashland, MA (US)

(21) Appl. No.: 15/366,843

(22) Filed: Dec. 1, 2016

Related U.S. Application Data
(60) Provisional application No. 62/261,524, filed on Dec. 1, 2015.

(51) Int. Cl. G06Q 20/32; G06Q 20/40; G06Q 20/10; G06Q 20/36; G06Q 20/20

(52) U.S. Cl. CPC G06Q 20/3226; G06Q 20/36; G06Q 20/3278; G06Q 20/202; G06Q 20/10; G06Q 20/405

(57) ABSTRACT

The invention relates to hardware functionality mechanisms for facilitating e-commerce payments through a mobile device. In certain embodiments, virtual hardware device mechanisms are disclosed for facilitating e-commerce payments through a mobile device. Virtual cloud based POS models are described for facilitating e-commerce payments through a mobile device. In certain embodiments, the invention provides an interoperability hardware mechanism for facilitating e-commerce payments through a mobile device. Systems and methods of the invention secure and mitigate use of smartphone payment system from the use in terrorism using metadata. In certain embodiments, systems and methods of the invention provide security of payments, transactions and transfers within the smartphone payment system.

### CROSS-REFERENCE TO RELATED APPLICATIONS

This application claims priority to U.S. Provisional patent application Ser. No. 62/261,524, filed Dec. 1, 2015, the contents of which are herein incorporated by reference in their entirety.

### FIELD OF THE INVENTION

The present invention relates to e-commerce platforms.

### BACKGROUND

Traditional global retail market in the United States of America is US$22 trillion according to eMarketer (Barbara Farfan s for retail purchases. With the release of examples including Apple Pay, Samsung Pay, Google Pay, Android Pay, Moven, the collectively called “smartphone payment system” technology has become more an more popular every day. Smartphone payment systems are digital/virtual versions of a traditional wallet, holding the electronic information of credit/debit cards for making payments and joining loyalty programs. Where the user may take this mobile hardware device, tap it next to the credit card reader device or cash register—which facilitates the payment.

The global ecommerce market size is expected to be US$1.4 trillion in 2015. U.S. online retail sales are expected to hit US$370 billion in 2017. According to Internet Retailer, the US online retail market has been growing at an average of 15% a year since 2010. (Allison Enright, internetretailer.com, “U.S. annual e-retail sales surpass $300 billion for the first time”, Feb. 17, 2015) The global ecommerce market size is set to grow 25% in 2015 alone. (Matt Linder, internetretailer.com, “Global e-commerce sales set to grow 25% in 2015”, Jul. 29, 2015) To date, there is no machine, mechanism, or hardware to use smartphone payment systems for facilitating such e-commerce purchases on, for example, SendItLater.com, Amazon.com and all ecommerce sites.

The mobile device while being able to interface with a cash register or a POS system that can process a retail transaction though Near Field Communication (NFC) or other technologies (Ex. MST), the challenge is to integrate with a PC or mobile device to be used for ecommerce transactions. Additionally, security of all payments and transaction, especially international ones, is challenging. Further, could such payment be used for terrorism. The challenge is to mitigate and detect potential use of these inventions for terrorism.

### SUMMARY

The invention relates to hardware functionality mechanisms for facilitating e-commerce payments through a mobile device. In certain embodiments, virtual hardware device mechanisms are disclosed for facilitating e-commerce payments through a mobile device. Virtual cloud based POS models are described for facilitating e-commerce payments through a mobile device. In certain embodiments, the invention provides an interoperability hardware mechanism for facilitating e-commerce payments through a mobile device. Systems and methods of the invention secure and mitigate use of smartphone payment system from the use in terrorism using metadata. In certain embodiments, systems and methods of the invention provide security of payments, transactions and transfers within the smartphone payment system.

Aspects of the invention include: A system and method to enable a user to use a mobile hardware device through the use of an additional hardware (Smartphone Hardware+) improvement to the device to facilitate e-commerce purchases; The functions of this new additional hardware (Smartphone Hardware+) would be to accept payment information and its encryption and activate the present payment mechanism on smart phone devices such as Samsung Pay, Apple Pay, Android Pay and Google Wallet; An alternative system and method and architecture (Virtual Cloud Based POS+) to facilitate e-commerce payments that originate from a PC or a mobile device, by adding a new hardware device that would virtualize a payment register system. This Virtual Cloud Based POS+Hardware provides the function of making the PC look like a POS terminal; Another alternative system and method and architecture that would enable a mobile payment for e-commerce using our hardware invention of a communication mechanism between these hardware components: existing components including a point of sale (POS) terminal, a PC and a mobile payment device.

Some parts of claim 1 (Smartphone Hardware+) could be simulated by having apps on the smartphone talk to other apps complimented with the interoperability hardware (4) that is part of this invention.

This interoperability hardware (4) can be generalized to allow data transfer between multiple mobile apps.

A system and method and architecture, hardware to allow e-commerce payments on all three methods (1,2,3 Above) for enabling e-payments through mobile devices to be secure and mitigated from the use in terrorism using metadata (5) (sender, receiver, date, address and message)

A system and method and architecture implemented with augmented hardware (6) to invention 1,2,3 that secures data transmission throughout all three methods for enabling e-payments through mobile devices using meta data with special focus mitigating, hacking, denial of service, and spoofing. Within the devices, and within the network.

### FIELD OF INVENTION

Smartphone Payment System, Mobile Apps, Mobile Payments, Mobile Wallets, E-Commerce, RFID and NFC Terminal Payments, MST Payments, In App Purchases via Apps, Multi-Factor Authentication for E-commerce, Security and Terrorism, Bluetooth, POS Systems, Virtual POS Systems, E-Commerce Payments, Mobile Devices, Desktop, Payment Platforms, Wi-Fi, Meta-Data, Mobile Communication Devices, Payment Systems, RFID reader, NFC reader, Data

### BRIEF DESCRIPTION OF THE DRAWINGS

FIG. 1 shows E-commerce sales growth for past 5 years (2010-2015).

FIG. 2 shows past, present and predicted future US online retail sales (2012-2017)

FIG. 3 shows functions of the hardware according to certain embodiments.

FIG. 4 shows a process flow for e-commerce transactions using smartphone payment system via a hardware functionality mechanism

FIG. 5 shows a process flow for e-commerce transactions using smartphone payment system via virtual hardware device mechanism.

FIG. 6 shows a process flow for e-commerce transactions using smartphone payment system via a virtual cloud based POS system.

FIG. 7 shows a process flow for e-commerce transactions using smartphone payment system via an interoperability hardware mechanism.

FIG. 8 shows process flow for e-commerce transactions using smartphone payment system via rfid/nfc device.

### DETAILED DESCRIPTION

The present invention provides machine, hardware, or other mechanisms and enable mobile hardware devices such as smart phones and tablets for secure, efficient, convenient e-commerce payments. See US20130035970, U.S. Pat. No. 8,041,338, EP2787476, U.S. Pat. No. 8,768,834, and US20140279479, the contents of each of which are incorporated by reference.

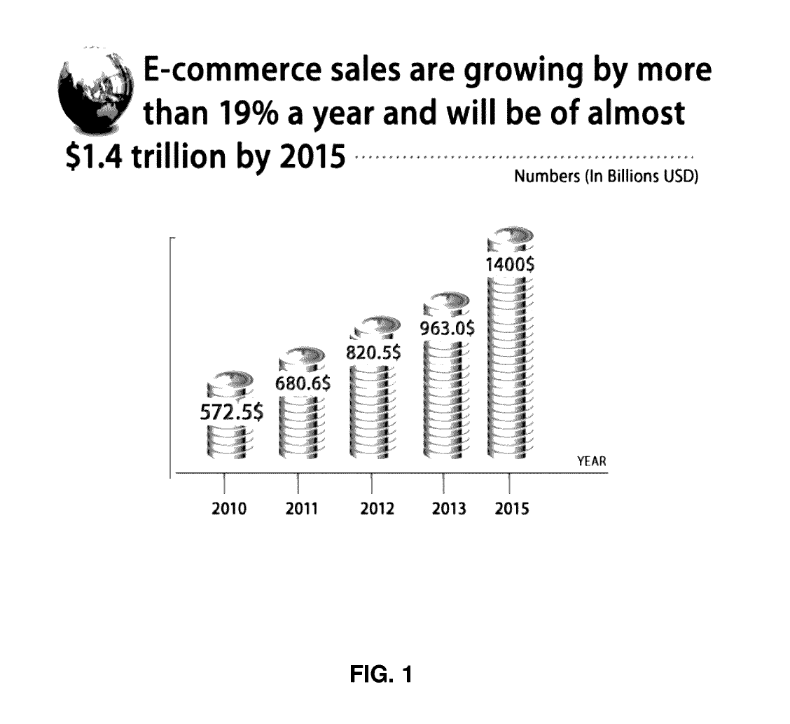

FIG. 1 shows E-commerce sales growth for past 5 years (2010-2015). Source: (Visually, “How big is E-Commerce?”, Jan. 24, 2012).

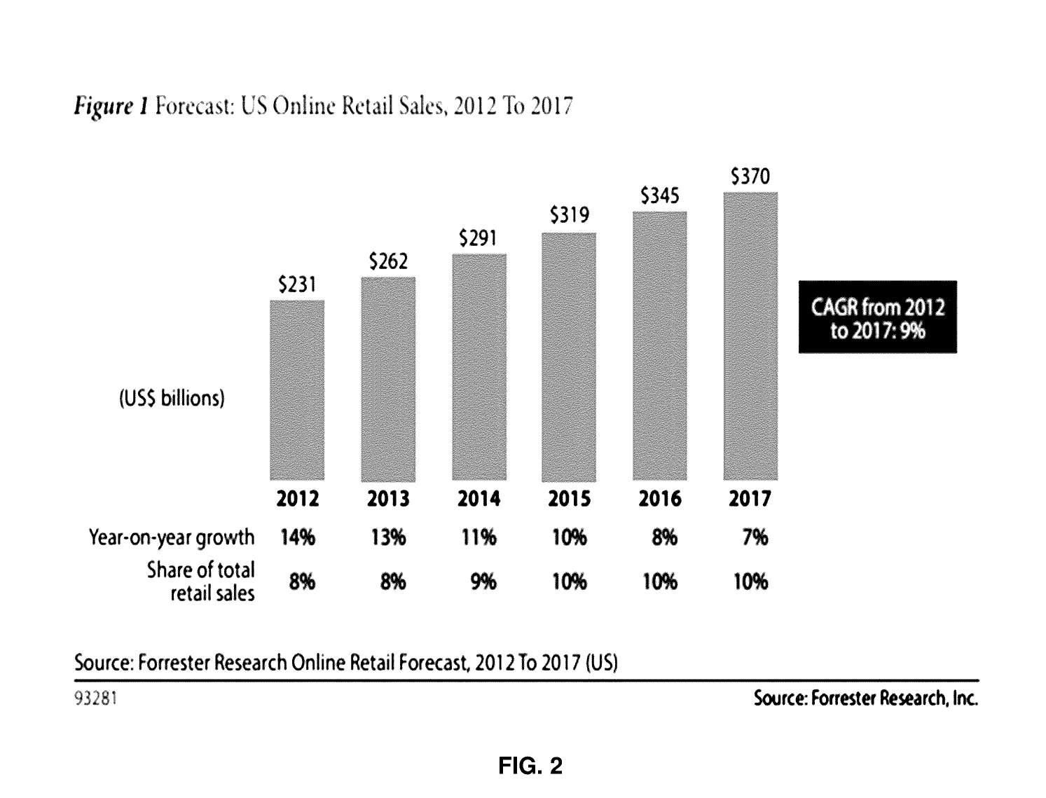

FIG. 2 shows past, present and predicted future us online retail sales (2012-2017). Source: (Lauren Indvik, Mashable, “Forrester: U.S. Online Retail Sales to Hit $370 Billion by 2017”, Mar. 12, 2013)

1. Hardware Functionality Mechanism for Facilitating E-commerce Payments through a Mobile Device

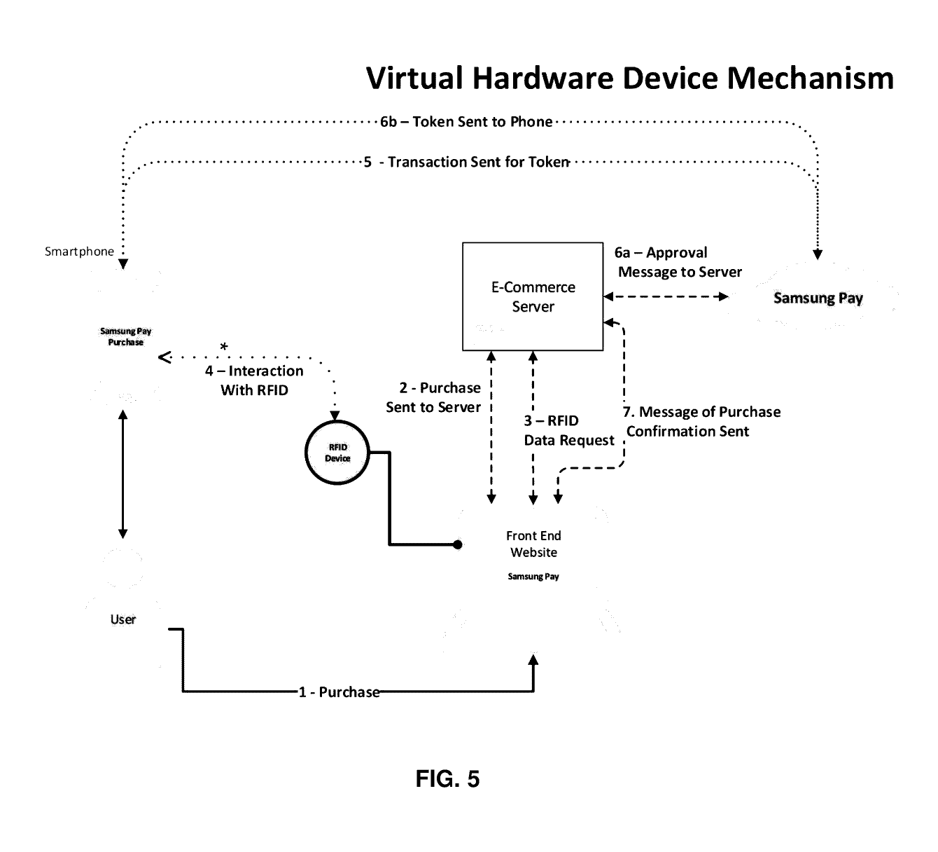

FIG. 4 depicts a system and method for using a mobile phone with an existing smartphone payment system on it (Google Pay, Samsung Pay, Apple Pay, etc.). The heart of the invention is to create an interaction between the smartphone payment system and the smartphone. The major functions of this new hardware are:
a. Hardware receives, from the enhanced, with our invented communication device, E-Commerce server, a function of: the amount of the purchase fₜ(Money, Currency) where t is the format of the ecommerce site.
b. The hardware converts this function to the retailer format fᵣ(Money, Currency) where r is the format of the retailer.
c. The smartphone payment system then securely verifies the transaction and sends approval which is a function fᵣ(Amount, Currency, Transaction ID, Validation) to the new mechanism and then to server.
d. The new hardware coupled with the existing hardware will display the approval on the mobile device.
e. This invention encompasses the necessary modifications required of the smartphone payment system, the service, the cloud mechanism to facilitate all of this as described below.

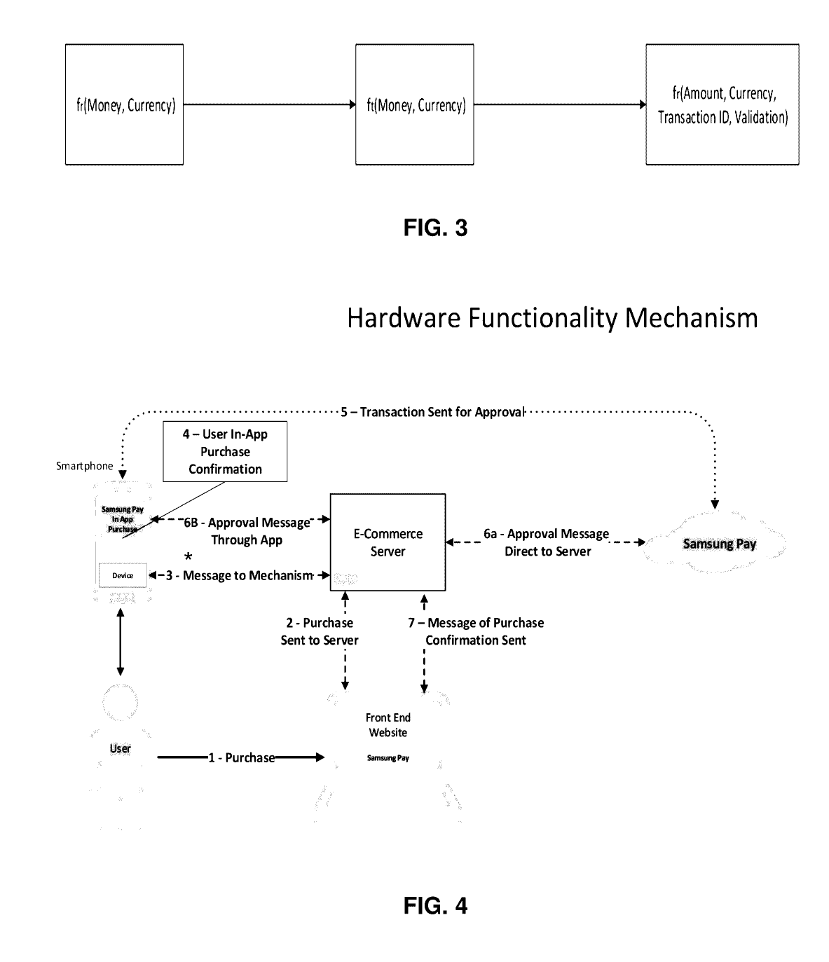

FIG. 3 is a more precise definition of the functions of the hardware. Where, the boxes depict the functions and the data that is being transformed where the arrows represent the transformational operation. The variables are: Money (The purchase price of the e-commerce good or service), Currency (the world accepted currency), transaction ID (unique identification of the e-commerce transaction being conducted), Validation (is the resulting verification that the user has the funds to complete transaction).

2. Virtual Hardware Device Mechanism for Facilitating E-commerce Payments through a Mobile Device

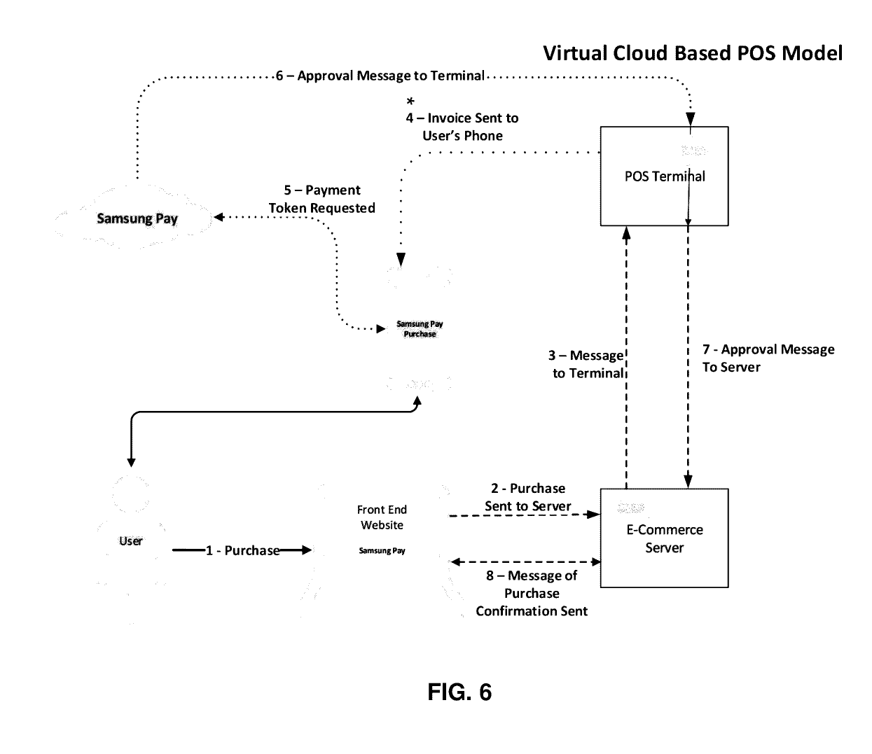

FIG. 5 depicts the flow of the addition of hardware to the PC or mobile device to facilitate ecommerce with mobile payments. The essence of this invention is an additional hardware device that would be attached to the PC or mobile device that would virtualize a traditional point of sale (POS) device that the mobile payment is used to dealing with. The major functions of the invented hardware are:
a. The enhanced, with our invented communication device, E-Commerce server receives from the E-commerce website a request for purchase completion. This is a function of: the amount of the purchase, and validation of purchase fₜ(Money, Currency) where t is the format of the Ecommerce site.
b. The enhanced, with our invented communication device, E-Commerce server sends a request for purchase validation to the invented Hardware device. This is a function fᵣ(Money, Currency) where r is the format of the retailer.
c. The smartphone payment system then securely validates the transaction and sends approval which is a function fᵣ(Amount, Currency, Who, Validation) to the server.
d. The server sends message of approval to E-Commerce site.
e. This invention encompasses the necessary modifications required of the smartphone payment system, the service, the cloud mechanism to facilitate all of this as described below.

FIG. 3 is a more precise definition of the functions of the hardware. Where, the boxes depict the functions and the data that is being transformed where the arrows represent the transformational operation. The variables are: Money (The purchase price of the e-commerce good or service), Currency (the world accepted currency), transaction ID (unique identification of the e-commerce transaction being conducted), Validation (is the resulting verification that the user has the funds to complete transaction).

3. Virtual Cloud Based POS Model for Facilitating E-commerce Payments through a Mobile Device

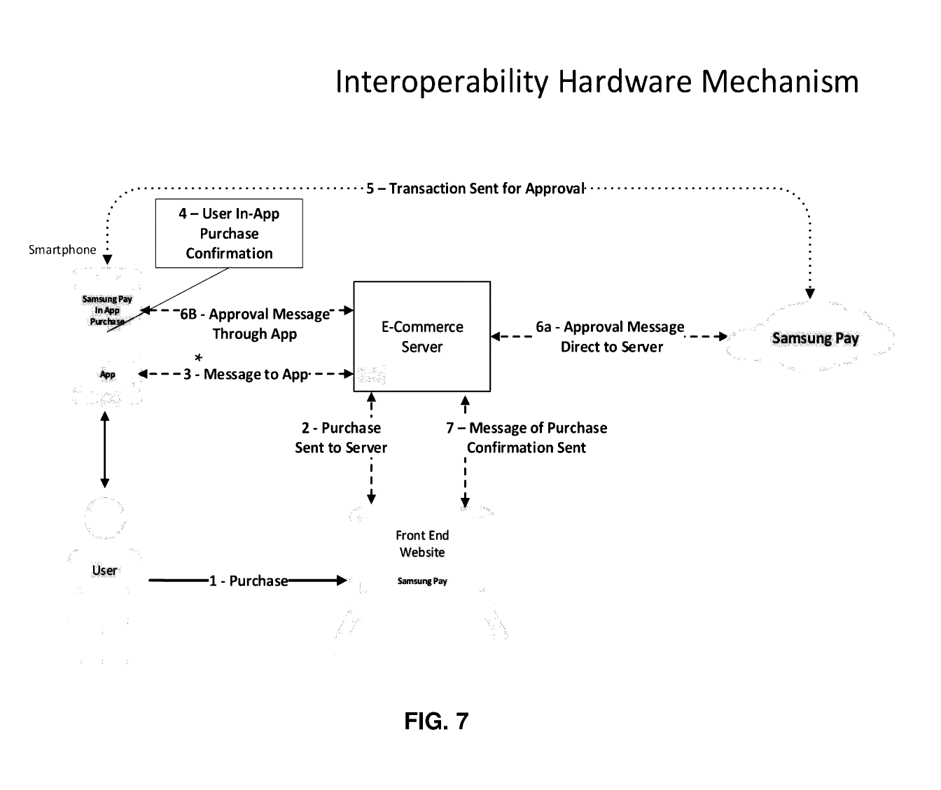

FIG. 6 depicts the use of an existing POS terminal with our communication inventions added to each of these communication devices. The major functions of the added communication device to the POS Terminal are:
a. The enhanced, with our invented communication device, POS Terminal receives from the, enhanced with our invented communication device, E-commerce server a request for purchase completion. This is a function of: the amount of the purchase, and validation of purchase fₜ(Money, Currency) where t is the format of the ecommerce site.
b. The E-Commerce server enhanced with our communication device sends a request for purchase validation to the enhance, without invented communication device, POS Terminal, this is a function fᵣ(Money, Currency) where r is the format of the retailer.
c. The smartphone payment system then securely validates the transaction and sends approval which is a function fᵣ(Amount, Who, Validation) to the enhanced POS terminal.
d. The enhanced, with our communication device, POS Terminal sends message of approval on mobile device E-Commerce server which then send approval to enhanced, without communication device, E-Commerce website.
e. This invention encompasses the necessary modifications required of the smartphone payment system, the service, the cloud mechanism to facilitate all of this as described below.

FIG. 3 is a more precise definition of the functions of the hardware. Where, the boxes depict the functions and the data that is being transformed where the arrows represent the transformational operation. The variables are: Money (The purchase price of the e-commerce good or service), Currency (the world accepted currency), transaction ID (unique identification of the e-commerce transaction being conducted), Validation (is the resulting verification that the user has the funds to complete transaction).

4. Interoperability Hardware Mechanism for Facilitating E-commerce Payments through a Mobile Device

Invention 1, where we are using a hardware device to complete the purchase by interfacing with the smartphone payment mechanism, can be simulated with an app. If there is a mechanism of having that app communicate with a payment app. That mechanism can either be hardware or simulated with software. The function of that simulated app is as follows:
a. The simulated mechanism receives, from the enhanced, with our invented communication device, E-Commerce server, a function of: the amount of the purchase fₜ(Money, Currency) where t is the format of the ecommerce site.
b. The simulated mechanism converts this function to the retailer format fᵣ(Money,

Currency) where r is the format of the retailer.
c. The smartphone payment system then securely verifies the transaction and sends approval which is a function fᵣ(Amount, Currency, Transaction ID, Validation) to the new mechanism and then to server.
d. The new simulated mechanism displays approval on mobile device.
e. This invention would need necessary modifications required of the smartphone payment system, the service, the cloud mechanism, as well as a communication mechanism between apps to facilitate all of this as described below.

FIG. 3 is a more precise definition of the function that must take place. Where, the boxes depict the functions and the data that is being transformed where the arrows represent the transformational operation. The variables are: Money (The purchase price of the e-commerce good or service), Currency (the world accepted currency), transaction ID (unique identification of the e-commerce transaction being conducted), Validation (is the resulting verification that the user has the funds to complete transaction).
5. Secure and Mitigate Use of Smartphone Payment System from the use in Terrorism using Metadata

In all three inventions transactions go through a server, smartphone, smartphone payment system, invented hardware devices within the POS terminals, e-commerce server, and smartphone, and our communication devices, and networks that connect all of these, both locally and on the internet. There are opportunities for bad people to use these devices and networks for transferring money that would be used for terrorism. This invention uncaptured in a machine uses data and meta data, to detect (weightings to each of the meta data values, these then would be summed in a machine using regression analysis) the possibility and alert the appropriate authorities. Equation 1 below expresses the calculation that the machine would follow.

$${alerts}_{j} = {\sum }_{i = 1}^{n} {w}_{i} {x}_{i} \qquad Equation 1$$

Where: x is meta data associated with i

w is the weight given to that meta data associated with i

alertsⱼ is the alert sent to the appropriate authority j

Examples of weighting would be on a scale of 1 to 10, the date, September 11, would be weighted very high. The meta data associated with a tip, if a tip was from a reliable informant, would be higher that an anonymous tip. This hardware system would be added to all the hardware inventions 1,2,3, and would use meta data, including:
1. The DNS route that an individual user takes in getting to the bank
2. Inconsistent I.P addresses
3. Location of the user
4. The Delta of withdrawals
5. Identify use of data from social networking, Facebook, twitter, etc. to predict the potential threats
6. Forum of technical people
7. Forum of financial people
8. News Articles
9. Google Searches of invented devices
10. Total money spent
11. Tips
12. National GDP's around the world
13. Disposable Income
14. World unrest
15. Government Regulations
16. Laws that change
17. Natural disasters
18. User's Gender
19. User's Age
20. Receiving financial institution's history
21. Receiving financial institution's location
22. Receiving financial institution's authenticity
23. Receiving financial institution's longevity
24. Receiving financial institution's ties to terrorist organizations
25. Receiving financial institution's ties to individuals
26. Receiver Age
27. Receiver Religion
28. Receiver Ethnicity
29. Receiver Gender
30. Past Transactions
31. User's Religion
32. User's Background
33. User's Ethnicity
34. User's Spending habits
35. User's Credit score
36. Amount of Purchases
37. Time of Year
38. Time of Purchases
39. Time of Transaction
40. Percentage of none completed transaction
41. Percentage of credit card denials
42. E-commerce hits
43. Volume Customers
44. The change of the route of the user

6. Security of Payments, Transactions and Transfers within the Smartphone Payment System

Security of payments, transactions and transfers within the smartphone payment system is a system which guarantees the security of payment processes for both purchaser and vendor. This hardware system would be added to all the hardware inventions 1,2,3, and encrypts and secures data transmission between them.

Equation 2 below expresses the calculation that the machine would follow.

$${alerts}_{j} = {\sum }_{i = 1}^{n} {w}_{i} {x}_{i} \qquad Equation 2$$

Where: x is meta data associated with i

w is the weight given to that meta data associated with i

alertsⱼ is the alert sent to the appropriate authority j

Examples of weighting would be on a scale of 1 to 10, the date, September 11, would be weighted very high. The meta data associated with a tip, if a tip was from a reliable informant, would be higher that an anonymous tip. This hardware would use meta data (weightings to each of the meta data values, these then would be summed in a machine using regression analysis) to combat the following types of security breaches with associated meta data.

Hacking

Meta-data retrieved to prevent hacking will include:
1. The DNS route that an individual user takes in getting to the bank
2. Inconsistent I.P addresses
3. Location of the user
4. The Delta of withdrawals
5. Identify use of data from social networking, Facebook, twitter, etc. to predict the potential threats
6. Forum of technical people
7. Forum of financial people
8. News Articles
9. Google Searches
10. Total spent
11. Consumer prices, utilities, electricity
12. National GDP's around the world
13. Identify baskets and individual stock
14. Disposable Income
15. World unrest
16. Government Regulations
17. Laws that change
18. Natural disasters
19. Customer's Gender
20. Customer's Age
21. Receiver Age
22. Receiver Religion
23. Receiver Ethnicity
24. Receiver Gender
25. Past Transactions
26. Customer's Religion
27. Customer's Background
28. Customer's Ethnicity
29. Customer's Spending habits
30. Customer's Credit score
31. Amount Purchases
32. Time of Year
33. Time of Purchases
34. Time of Transaction
35. Percentage of none completed transaction

Denial of Service

Meta-data retrieved to prevent Denial of Service will include:
1. E-commerce hits
2. Volume Customers
3. Inconsistent I.P addresses
4. Location of the user
5. The Delta of withdrawals
6. Identify use of data from social networking, Facebook, twitter, etc. to predict the potential threats
7. Forum of technical people
8. Forum of financial people
9. News Articles
10. Google Searches
11. Total spent
12. Consumer prices, utilities, electricity
13. National GDP's around the world
14. Identify baskets and individual stock
15. Disposable Income
16. World unrest
17. Government Regulations
18. Laws that change
19. Natural disasters
20. Customer's Gender
21. Customer's Age
22. Receiver Age
23. Receiver Religion
24. Receiver Ethnicity
25. Receiver Gender
26. Past Transactions
27. Customer's Religion
28. Customer's Background
29. Customer's Ethnicity
30. Customer's Spending habits
31. Customer's Credit score
32. Amount Purchases
33. Time of Year
34. Time of Purchases
35. Time of Transaction
36. Percentage of none completed transaction

Spoofing
1. The change of the route of the user
2. E-commerce hits
3. Volume Customers
4. Inconsistent I.P addresses
5. Location of the user
6. The Delta of withdrawals
7. Identify use of data from social networking, Facebook, twitter, etc. to predict the potential threats
8. Forum of technical people
9. Forum of financial people
10. News Articles
11. Google Searches
12. Total spent
13. Consumer prices, utilities, electricity
14. National GDP's around the world
15. Identify baskets and individual stock
16. Disposable Income
17. World unrest
18. Government Regulations
19. Laws that change
20. Natural disasters
21. Customer's Gender
22. Customer's Age
23. Receiver Age
24. Receiver Religion
25. Receiver Ethnicity
26. Receiver Gender
27. Past Transactions
28. Customer's Religion
29. Customer's Background
30. Customer's Ethnicity
31. Customer's Spending habits
32. Customer's Credit score
33. Amount Purchases
34. Time of Year
35. Time of Purchases
36. Time of Transaction
37. Percentage of none completed transaction

For FIGS. 4-7, a solid line indicates a direct contact, a dashed line indicates in-server connectivity, and a dotted line indicates outside server communication.

FIG. 4 shows a process flow for e-commerce transactions using smartphone payment system via a hardware functionality mechanism

Hardware Functionality Mechanism for Facilitating E-commerce Payments through a Mobile Device

Step 1—Purchase

User goes to the front end website and makes purchase. They select payment with Samsung Pay or another mobile payment option.

Step 2—Purchase sent to server

Front end website receives the purchase request, sends the request to the enhanced, with our invented communication device, website's e-commerce server.

Step 3—Message to Hardware Functionality Mechanism

The enhanced, with our invented communication device, Ecommerce server sends a message detailing purchase request including data on the purchase to the hardware functionality mechanism (device) for the website.

* Step where security process is engaged

Step 4—User in-App Purchase Confirmation

Hardware functionality mechanism (device) interacts with Samsung Pay, prompting the user to confirm the purchase.

Step 5—Transaction Sent for Approval

Once the user has successfully confirmed the purchase in the hardware functionality mechanism, the transaction information is gathered and sent to Samsung Pay for processing and approval.

Step 6a—Approval Message Direct to Server

Samsung Pay processes transaction and sends message of purchase approval directly to the e-commerce server.

Step 6b—Approval Message sent through App

Samsung Pay processes transaction and sends message of purchase approval to the hardware functionality mechanism (device) for the front end website. The app then sends an approval message to the e-commerce server.

Step 7—Message of Purchase Confirmation Sent

The enhanced, with our invented communication device, server tells website that transaction has processed. Customer receives confirmation that purchase has been approved on the front end website.

FIG. 5 shows a process flow for e-commerce transactions using smartphone payment system via virtual hardware device mechanism.

Virtual Hardware Device Mechanism for Facilitating E-commerce Payments through a Mobile Device

Step 1—Purchase

User goes to a front end website and makes purchase. They select payment with Samsung Pay or another mobile payment option.

Step 2—Purchase Sent to Server

Front end website receives the purchase request, sends the request to website's the enhanced, with our invented communication device, e-commerce server.

Step 3—RFID Data Request

The enhanced, with our invented communication device, e-commerce server requests payment information from the enhanced, with our invented communication device, RFID Hardware device on user's machine.

Step 4—Interaction with RFID

Front end website prompts user for payment. User interacts with the enhanced, with our invented communication device, RFID Hardware device to pay using phone.

* Step where security process is engaged

Step 5—Transaction Sent for Token

Once the user confirmed the purchase, the transaction information is sent to Samsung Pay for token and approval.

Step 6a—Approval Message to server

Samsung Pay processes transaction and sends approval message directly to the enhanced, with our invented communication device, e-commerce server.

Step 6b—Token sent to phone

Samsung Pay processes transaction and sends approval message to the user's phone.

Step 7—Message of Purchase Confirmation sent

The enhanced, with our invented communication device, server tells website that transaction has processed. Customer receives message of confirmation that purchase has been approved on the front end website.

FIG. 6 shows a process flow for e-commerce transactions using smartphone payment system via a virtual cloud based POS system.

Virtual Cloud Based POS Model for Facilitating E-commerce Payments through a Mobile Device

Step 1—Purchase

User goes to a front end website and makes purchase. They select payment with Samsung Pay or another mobile payment option.

Step 2—Purchase Sent to Server

Front end website receives the purchase request, sends the request to website's the enhanced, with our invented communication device, e-commerce server.

Step 3—Message to Terminal

The enhanced, with our invented communication device, e-commerce server sends a message detailing purchase information to the enhanced, with our invented communication device, POS terminal.

Step 4—Invoice sent to user's Phone

The enhanced, with our invented communication device, POS terminal sends an invoice to the user's phone to open up Samsung Pay and confirm purchase.

* Step where security process is engaged

Step 5—Payment Token Requested

Once the user has successfully confirmed the purchase, the payment token is requested and sent to Samsung Pay for processing and approval.

Step 6—Approval Message to Terminal

Samsung Pay approves the transaction and sends message back to the enhanced, with our invented communication device, POS terminal.

Step 7—Approval Message to server

The enhanced, with our invented communication device, POS Terminal sends message of purchase approval to the enhanced, with our invented communication device, e-Commerce server

Step 8—Message of Purchase Confirmation Sent

The enhanced, with our invented communication device, server tells front end website that transaction has processed. Customer receives message of confirmation that purchase has been approved on the front end website.

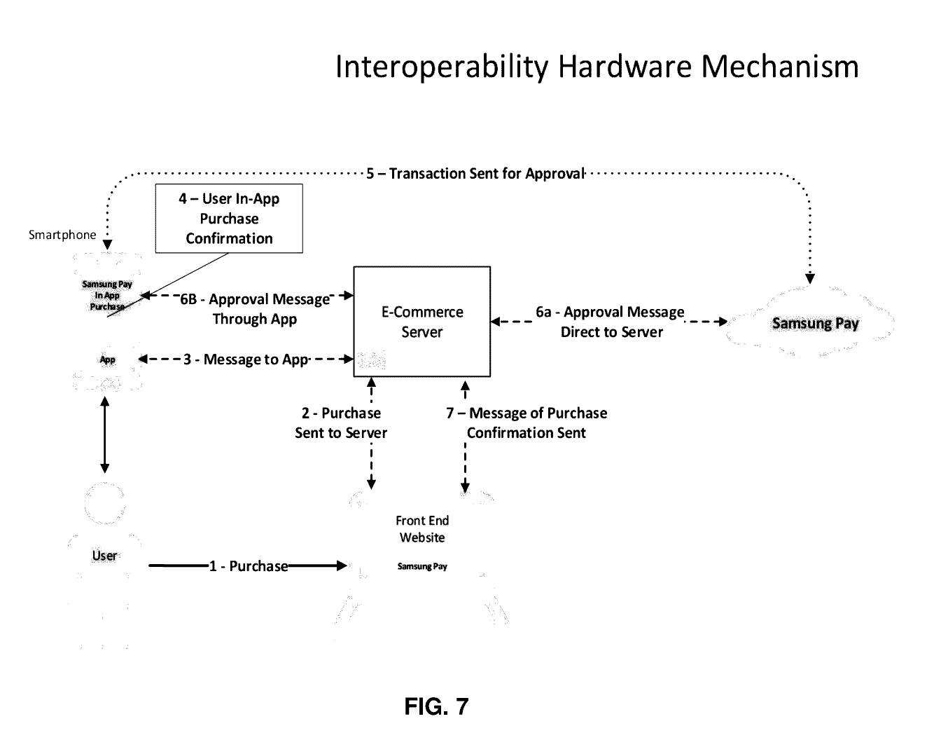

FIG. 7 shows a process flow for e-commerce transactions using smartphone payment system via an interoperability hardware mechanism.

Interoperability Hardware Mechanism for Facilitating E-commerce Payments through a Mobile Device

Step 1—Purchase

User goes to the front end website and makes purchase. They select payment with Samsung Pay or another mobile payment option.

Step 2—Purchase sent to server

Front end website receives the purchase request, sends the request to website's enhanced, with our invented communication device, e-commerce server.

Step 3—Message to Hardware Functionality Mechanism

The enhanced, with our invented communication device, ecommerce server sends a message detailing purchase request including data on the purchase to the app on smartphone for the website.

* Step where security process is engaged

Step 4—User in-App Purchase Confirmation

App interacts with Samsung Pay, prompting the user to confirm the purchase.

Step 5—Transaction Sent for Approval

Once the user has successfully confirmed the purchase in the app, the transaction information is gathered and sent to Samsung Pay for processing and approval.

Step 6a—Approval Message Direct to Server

Samsung Pay processes transaction and sends message of purchase approval directly to the enhanced, with our invented communication device, e-commerce server.

Step 6b—Approval Message sent through App

Samsung Pay processes transaction and sends message of purchase approval to the app for the front end website. The app then sends an approval message to the enhanced, with our invented communication device, e-commerce server.

Step 7—Message of Purchase Confirmation Sent

The enhanced, with our invented communication device, server tells website that transaction has processed. Customer receives confirmation that purchase has been approved on the front end website.

Hardware Functionality Mechanism for Facilitating E-commerce Payments through a Mobile Device:

RFID Model for Facilitating E-commerce Payments through a Mobile Device:

Virtual Cloud Based POS System for Facilitating E-commerce Payments through a Mobile Device:

Implementation

Hardware Functionality Mechanism for Facilitating E-commerce Payments through a Mobile Device
Hardware receives message with vendor and amount and purchase details from CIC server
User securely acknowledge the purchase using available payment mechanism
Optional: May need to get the success message from pay mechanism and forward that back to CIC server

RFID Model for Facilitating E-commerce Payments through a Mobile Device
Virtual Cloud Based POS with Remote RFID/NFC hardware accessibility via web
Web page request access to start RFID hardware device
Turn on RFID/NFC to listen
Listen for code
Route code to payment platform in cloud or Web site gets code and interacts with payment platform in cloud
Server side system to securely communicate with client side shim (smartphone payment system) to interface with local hardware
Create a virtualized interface to local physical hardware including: RFID/NFC or Bluetooth

Virtual Cloud Based POS System for Facilitating E-commerce Payments through a Mobile Device
Route code to payment platform in cloud or Web site gets code and interacts with payment platform in cloud
Server side system to securely communicate with client side shim (smartphone payment system) to interface with local hardware
Create a virtualized interface to external POS hardware system

Interoperability Hardware Mechanism for Facilitating E-commerce Payments through a Mobile Device
Receive message with vendor and amount and purchase details from CIC server
User securely acknowledge the purchase using available payment mechanism
Optional: May need to get the success message from pay mechanism and forward that back to CIC server

### Examples

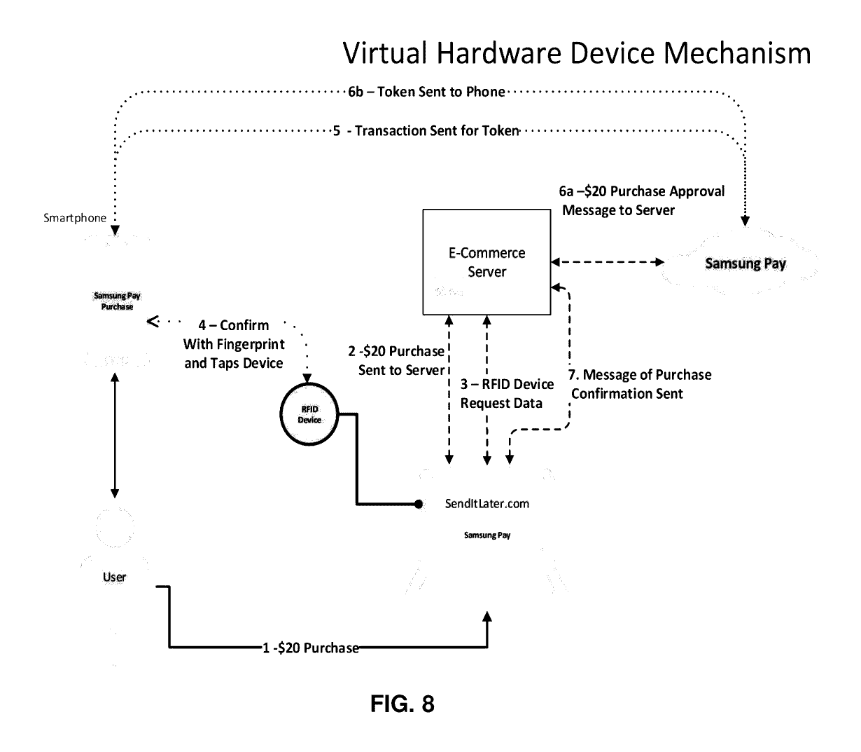

FIG. 8 shows process flow for e-commerce transactions using smartphone payment system via rfid/nfc device.

RFID Hardware Device model for Facilitating E-commerce Payments through a Mobile Device

Step 1—$20 Purchase

User goes to a website (SendItLater.com) and makes a $20 purchase. They select payment with Samsung Pay or another mobile payment option.

Step 2—$20 Purchase Sent to Server

SendItLater.com receives the $20 purchase request, sends the request to website's enhanced, with our invented communication device, e-commerce server.

Step 3—RFID Hardware Device Requests Data

The enhanced, with our invented communication device, e-commerce server requests payment information from RFID Hardware device on user's machine.

Step 4—Confirm with Fingerprint and Tap Device

SendItLater prompts user for payment. User uses fingerprint and taps phone to RFID Hardware device to pay using Samsung Pay.

Step 5—Transaction Sent for Token

Once the user confirmed the purchase, the transaction information is sent to Samsung Pay for token and approval.

Step 6a—$20 Purchase Approval Message to server

Samsung Pay processes transaction and sends approval message directly to the enhanced, with our invented communication device, e-commerce server.

Step 6b—Token sent to phone

Samsung Pay processes transaction and sends approval message to the user's phone.

Step 7—Message of Purchase Confirmation sent

The enhanced, with our invented communication device, server tells website that transaction has processed. Customer receives message of confirmation that purchase has been approved on SendItLater.com.

Definitions
1. As used herein, “E-Commerce” shall mean purchases of goods or services made on a website.
2. As used herein, “App” shall mean software used to perform a specific task or tasks.
3. As used herein, “Mobile App” shall mean software used to perform a specific task or tasks within a mobile device such as a smartphone or tablet.
4. As used herein, “Smartphone payment system” shall mean a hardware and software system used within a mobile device to complete and validate purchases, transfer money between smartphone payment systems, bank accounts, and credit/debit cards.
5. As used herein, “Mobile Wallet” shall mean an app used within mobile device to complete and validate purchases, transfer money between mobile wallets, bank accounts, and credit/debit cards.
6. As used herein, “Content Generation Apps” shall mean apps used within mobile device to create content, such as but not limited to pictures, videos, games, music, etc.
7. As used herein, “E-Payments” shall mean payments for goods and services that are completed online.
8. As used herein, “POS system”, or Point Of Sale system, shall mean hardware used to safely validate transactions using credit/debit cards, magnetic strips, NFC or crypto-currencies.
9. As used herein, “NFC”, or Near Field Communication, shall mean hardware used to safely communicate with other NFC enabled devices and exchange necessary information.
10. As used herein, “RFID”, or Radio Frequency Field Identification, shall mean, wireless transmission and exchange of information.
11. As used herein, “Multi-factor Authentication” shall describe the way the user can successfully validated to proceed and indicate the authorization of an action. They would need to present multiple, separate, forms of authentication through credentials based on knowledge, possession, and biometrics.

12. As used herein, the term “meta-data” shall designate data about data. Examples include: descriptive date about data, time stamps, validity of the data, source of the data, etc.

What is claimed is:

1. A method to facilitate e-commerce purchases through a mobile device, the method comprising providing a virtual payment register system on a mobile device to provide the look of a POS terminal.
